(19) United States
(12) Patent Application Publication
(10) Pub. No.: US 2004/0099212 A1
(43) Pub. Date: May 27, 2004

(54) Apparatus for applying thermoplastic marking material to a pavement surface

(75) Inventors: Robert A. Dirienzo, Stow, OH (US); Buddy Reed, Powder Springs, GA (US)

Correspondence Address: RANKIN, HILL, PORTER & CLARK, LLP, 925 EUCLID AVENUE, SUITE 700, CLEVELAND, OH, 44115-1405, US

(73) Assignee: LaFarge Road Marking, Inc., Parsippany, NJ (US)

(21) Appl. No.: 10/302,226

(22) Filed: Nov. 22, 2002

(51) Int. Cl. B05D 5/10

(52) U.S. Cl. 118/108; 427/136; 118/300; 404/110

(57) ABSTRACT

The present invention provides an apparatus for applying thermoplastic marking material to a pavement surface. The apparatus includes a hopper for holding a supply of particulate thermoplastic marking material in a non-molten state, a means for conveying the thermoplastic marking material from the hopper to a continuous melt processor, and a conduit from the continuous melt processor to a dispenser that directs molten thermoplastic marking material to the pavement surface. The apparatus further includes means for heating the continuous melt processor and conduit to a temperature that is higher than the melt temperature of the thermoplastic marking material. The present invention also provides a method of applying a thermoplastic marking material to a pavement surface. The method includes conveying a stream of particulate thermoplastic marking material stored in a non-molten state in a hopper to a heated continuous melt processor in communication with the hopper, wherein the stream of thermoplastic marking material exits the continuous melt processor in a molten state, and pumping the stream of molten thermoplastic marking material through a heated conduit from the continuous melt processor to a dispenser that directs the molten thermoplastic marking material to the pavement surface.

### BACKGROUND OF THE INVENTION

1. Field of Invention

The present invention relates to an apparatus for, and method of, applying thermoplastic marking material to a pavement surface.

2. Description of Related Art

Thermoplastic marking material is applied in a molten state by screed extrusion, ribbon gun or spray dispenser to pavement surfaces such as concrete, asphalt and tile. Upon application, the molten thermoplastic marking material quickly cools and solidifies to form a very durable and adherent mark on the pavement surface. Glass beads are sometimes dropped-onto the molten thermoplastic material before it solidifies to provide improved initial retroreflectivity.

The apparatus conventionally employed to apply thermoplastic marking material to pavement surfaces includes one or more heated hoppers or kettles that maintain a relatively large volume of thermoplastic marking material in a molten state. Some conventional application apparatus further include one or more “preheaters” that are used to melt an additional volume of thermoplastic marking material before it enters the heated hoppers or kettles. Such hoppers or kettles are typically oil jacketed and diesel or propane fired and can keep as much as 2,000 pounds or more of thermoplastic marking material in a molten state.

Although conventional apparatus and methods used to apply thermoplastic marking material to pavement surfaces are very effective, such apparatus and methods do present certain drawbacks. For example, it takes a significant amount of time to melt the relatively large volume of thermoplastic marking material kept in the kettle. This can cause delays before the pavement marking operation can be commenced. It also takes a significant amount of energy to keep a relatively large volume of thermoplastic marking material in a molten state. Moreover, once melted, the thermoplastic marking material must be continuously stirred to keep the various components of the marking material from separating and to prevent the thermoplastic marking material from undergoing thermal degradation.

### BRIEF SUMMARY OF THE INVENTION

The present invention provides an apparatus for, and a method of, applying thermoplastic marking material to a pavement surface. The apparatus according to the present invention comprises a hopper for holding a supply of particulate thermoplastic marking material in a non-molten state, a means for conveying the thermoplastic marking material from the hopper to a continuous melt processor, and a conduit from the continuous melt processor to a dispenser that directs molten thermoplastic marking material to the pavement surface. The apparatus also comprises means for heating the continuous melt processor, conduit and dispenser to a temperature that is higher than the melt temperature of the thermoplastic marking material. Electrical band heaters are the preferred means for heating the continuous melt processor. In accordance with the invention, the particulate thermoplastic marking material is stored in the hopper in a non-molten state, but is converted to a molten state by the time it exits the continuous melt processor.

The present invention also provides a method of applying a thermoplastic marking material to a pavement surface. The method comprises conveying a stream of particulate thermoplastic marking material stored in a non-molten state in a hopper to a heated continuous melt processor in communication with the hopper, wherein the stream of thermoplastic marking material exits the continuous melt processor in a molten state, and pumping molten thermoplastic marking material through a heated conduit from the continuous melt processor to a dispenser that directs the molten thermoplastic marking material to the pavement surface.

The apparatus and method according to the invention significantly reduce the time and energy needed to apply thermoplastic marking material to pavement surfaces. In addition, the apparatus and method according to the invention can be operated at relatively high speed. For example, the apparatus and method according to the invention can be used to apply a four to six inch wide, 0.090-inch thick, traffic stripe to a pavement surface at a speed of about 8 miles per hour.

The foregoing and other features of the invention are hereinafter more fully described and particularly pointed out in the claims, the following description setting forth in detail certain illustrative embodiments of the invention, these being indicative, however, of but a few of the various ways in which the principles of the present invention may be employed.

### BRIEF DESCRIPTION OF THE DRAWINGS

FIG. 1 is a perspective view of an exemplary apparatus for applying thermoplastic marking material to a pavement surface according to the invention.

FIG. 2 is a plan elevation of the apparatus shown in FIG. 1.

FIG. 3 is a side view of the apparatus shown in FIG. 1.

### DETAILED DESCRIPTION OF THE INVENTION

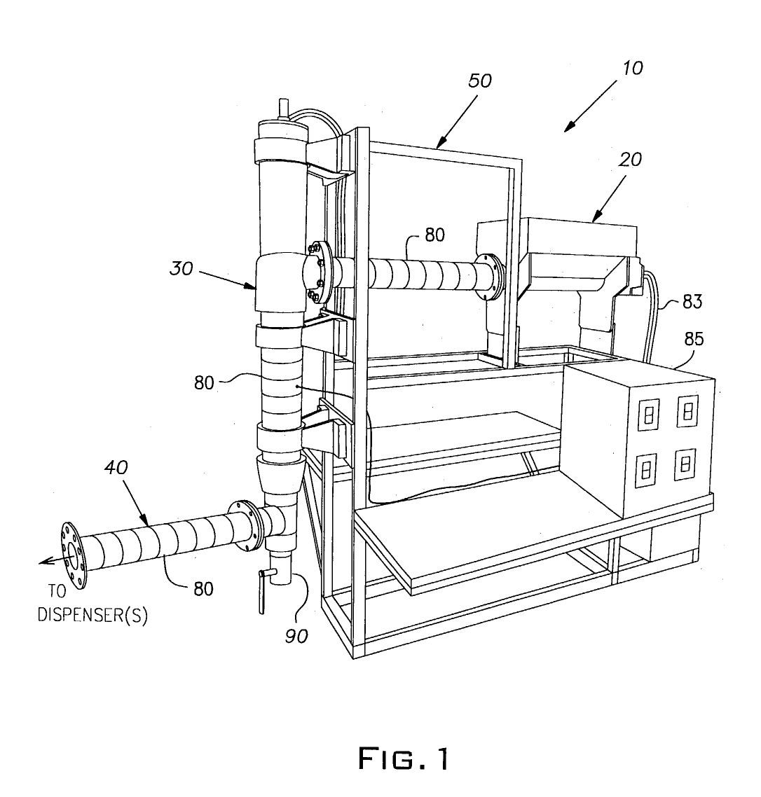

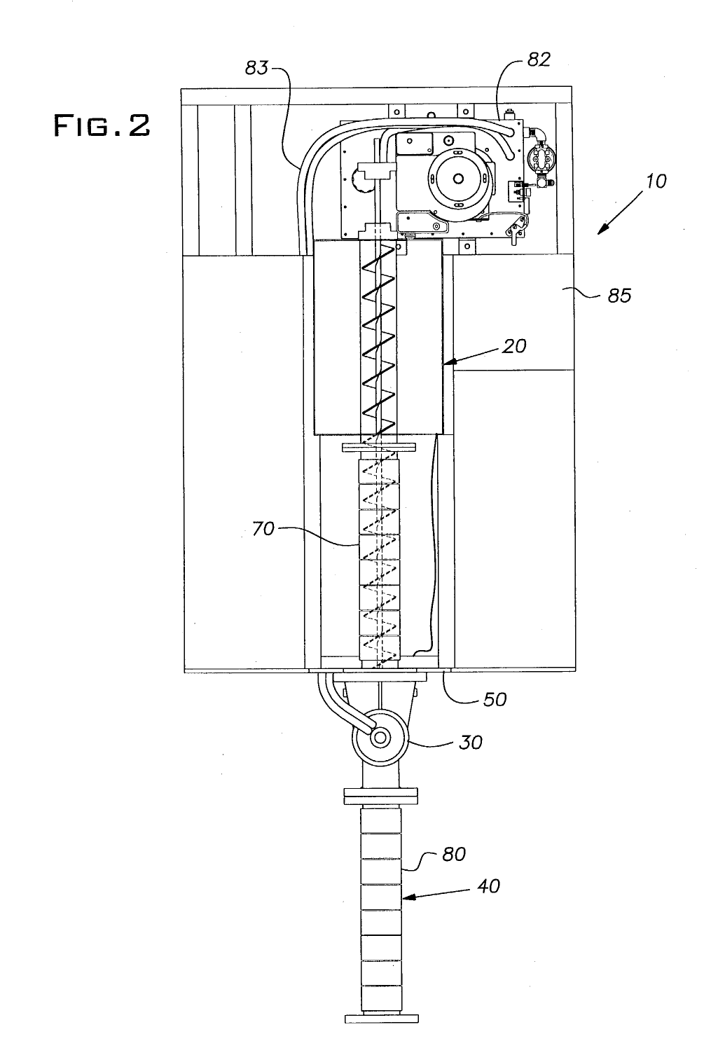

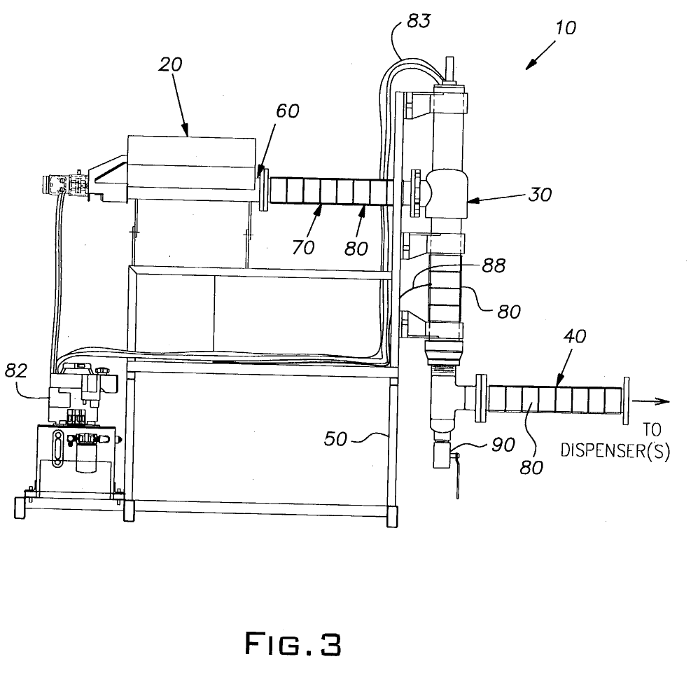

With reference to FIGS. 1 and 2, there is shown a perspective view and a plan elevation, respectively, of an exemplary apparatus 10 for applying thermoplastic marking material to a pavement surface in accordance with the present invention. FIG. 3 is a side view of the apparatus 10 shown in FIG. 1. The apparatus 10 comprises a hopper 20 for holding a supply of particulate thermoplastic marking material in a non-molten state, means for conveying the thermoplastic marking material from the hopper to a continuous melt processor 30, and a conduit 40 from the continuous melt processor to a dispenser (not shown) that directs molten thermoplastic marking material to the pavement surface. The apparatus 10 further comprises means for heating the continuous melt processor 30, conduit 40 and dispenser to a temperature that is higher than the melt temperature of the thermoplastic marking material. In the illustrated embodiment, the various components of the apparatus 10 are mounted to a rigid support frame 50.

In the preferred embodiment of the invention, the means for conveying the thermoplastic marking material from the hopper to the continuous melt processor is an auger 60. In FIG. 2, the auger screw can be seen in solid lines within the hopper 20, and in hidden (dashed) lines in a portion 70 that is encased within a tube proximal to the continuous melt processor 30. Rotation of the auger screw feeds a stream of particulate thermoplastic marking material that is in a non-molten state from the hopper 20 toward the continuous melt processor 30. In a preferred embodiment, the apparatus 10 further comprises means for heating the portion 70 of the auger 60 proximal to the continuous melt processor 30. Suitable means for heating the portion 70 of the auger 60 include electrical band heaters 80, recirculating hot oil, and hot air. Electrical band heaters are presently most preferred for heating the portion 70 of the auger 60 proximal to the continuous melt processor 30.

The apparatus 10 can utilize one or a plurality of dispensers that direct molten thermoplastic marking material to the pavement surface. When more than one dispenser is employed, the apparatus 10 preferably further comprises a manifold for selectively distributing molten thermoplastic marking material to the individual dispensers. The manifold is disposed in fluid communication between the continuous melt processor 30 and the plurality of dispensers and is also preferably heated.

The type and configuration of the dispenser(s) used to apply the molten thermoplastic marking material to the pavement surface is not per se critical to the invention, and a range of conventional thermoplastic marking material dispensers such as spray dispensers, screed extrusion devices and ribbon guns can be used. Profile dispensers (i.e., dispensers that arrange the thermoplastic material into alternating raised patterns on the pavement surface such as “rumble strips”) can also be used. The type of dispenser selected will depend on various factors, such as the intended thermoplastic marking material application rate and local regulations and preferences. Applicants have determined that thermoplastic spray guns available Lafarge Road Marking, Inc. of Parsippany, N.J. are particularly effective for applying thermoplastic marking material to pavement surfaces in a variety of applications, including long-line striping.

As previously noted, the apparatus 10 comprises means for heating the continuous melt processor 30 and conduit 40 to a temperature that is higher than the melt temperature of the thermoplastic marking material. Suitable means for heating the continuous melt processor 30 include electrical band heaters 80, recirculating hot oil, and hot air. The same or different means for heating the continuous melt processor 30 (e.g., electrical band heaters, recirculating hot oil, or hot air) can be used to heat the conduit 40. Electrical band heaters 80 are presently most preferred for heating the continuous melt processor 30 and conduit 40, and can also be used to heat the dispenser(s).

Any of the various types of electrical band heaters can be used, but mica band heaters are preferred. Mica band heaters are well known and are available in a variety of sizes and shapes from a variety of sources. A sufficient number of electrical band heaters must be used to melt the thermoplastic marking material and bring it to a temperature that will ensure adequate bonding of the thermoplastic marking material to the pavement surface. Temperatures within the range of from about 400° F. to about 500° F. are usually sufficient, depending upon the application conditions and surfaces. The electrical band heaters are preferably powered by an 80 amp generator, which can, but need not be, mounted to the frame 50. Generators are commercially available from a variety of sources.

The continuous melt processor can comprise a single-screw rotary pump, a twin-screw rotary pump, a continuous mixer, or any other processing equipment that continuously melts and pumps molten thermoplastic material. The preferred continuous melt processor for use in the invention is a progressing cavity pump. The pumping action of a progressing cavity pump is created by the rotation of a helical rotor within a double threaded helical stator. During rotation, the rotor and stator form a series of sealed cavities that are 180 degrees apart. As the rotor rotates, the cavities progress from a suction (or intake) end of the pump to a discharge (or exit) end of the pump. As one progressing cavity diminishes in volume, the opposing cavity increases in volume. Thus, the sum of the two discharges results in a constant volume and a pulsation-less flow.

Progressing cavity pumps are available from a variety of manufacturers including Moyno, Inc. of Springfield, Ohio. In the presently preferred embodiment of the invention, the progressing cavity pump is a hydraulically driven Moyno model 1L8CDD pump, which is a single stage pump having a cast iron suction housing and a hardened steel rotor and stator. In the embodiment of the invention illustrated in the accompanying figures, a hydraulic pump 82 pumps hydraulic fluid through hydraulic lines 83 to drive both the auger 60 and the continuous melt processor 30. When jacketed with electrical band heaters, this pump can be used to melt process and pump at least 16 gallons of molten thermoplastic marking material per minute, which facilitates the application of a four to six-inch wide, 0.090-inch thick stripe on a pavement surface at a speed of about 8 miles per hour.

The continuous melt processor must be capable of automatically adjusting the proper pressure/flow rate for the particular molten thermoplastic material dispensing demands. In the preferred embodiment, the continuous melt processor is powered by a hydraulic motor, which changes speed in relation to varying molten thermoplastic material dispensing demands. Infinite and variable pressure/flow rate control is thus obtained. An additional recirculation line around the pump can be used to maintain pump rotation during periods when molten thermoplastic marking material is not being dispensed. Use of a recirculation line tends to reduce pump wear.

Alternatively, a skip timer system can be used to turn the pump off when the dispensers are not in use and turn the pump back on when the dispensers are to be used. Skip timer systems, which are known, typically use an electronic skip line box that measures distance by means of electronic pulses. The skip line box continually monitors the amount of pulses generated and calculates the distance traveled. A controller uses this information to energize a solenoid valve that controls the air or hydraulic fluid that drives the dispenser(s) and pump.

In a preferred embodiment, the apparatus further comprises a command center 85 that provides a user of the apparatus with means to control various aspects of the pavement marking operation. Such means preferably include means to control the rate at which the stream of particulate thermoplastic marking material is fed into the continuous melt processor, means to control the temperature of the continuous melt processor, and means to control the dispensers that direct thermoplastic marking material to the pavement surface. At least one, and more preferably a plurality of thermocouples 88 are placed at various locations on the apparatus to monitor the temperature of the various components of the apparatus and/or the molten thermoplastic marking material. It will be appreciated that the location of the command center 85 is not per se critical, and can be located in any convenient location relative to the remaining components of the apparatus 10.

A flush valve 90 can be opened to purge the continuous melt processor of most molten thermoplastic marking material when the pavement marking operation has been completed. Any thermoplastic marking material is permitted to solidify in the continuous melt processor upon cooling. Thus, the majority of the thermoplastic marking material is exposed to heating conditions only once, which reduces the heat history in the material and also reduces the likelihood of thermal degradation.

The particulate thermoplastic marking material used in the present invention can be in the form of pellets, granules, flakes, powders or combinations thereof in its non-molten state. The specific form of the particulate is not critical, but it must be capable of being fed to the continuous melt processor. Conventional thermoplastic marking material typically comprises a mixture of a thermoplastic resin binder material(s), optional plasticizer(s), pigment(s), filler material(s) and retroreflective material(s) such as glass beads. Hydrocarbon, alkyd and other polymeric forms of thermoplastic marking material can be used in the apparatus.

The particulate thermoplastic marking material will generally transition from a solid non-molten state to a totally molten state when it reaches a temperature greater than the softening and/or melt point of the individual thermoplastic raw materials (components) used in the thermoplastic marking material. Temperatures typically in excess of about 220° F. are usually sufficient to cause the transition to occur. The rate at which the particulate thermoplastic marking material is converted from a non-molten state to a molten state depends on several factors including the initial temperature of the particulate thermoplastic marking material, the ambient temperature, the temperature of the various components of the apparatus, the form of the particulate thermoplastic marking material and the flow rate of material through the apparatus. Complete conversion from a particulate non-molten state to a pumpable molten state typically occurs in about eight seconds to five minutes in the apparatus.

The particulate thermoplastic marking material can be preheated in the hopper to a temperature below its softening and/or melting point (e.g., 150° F.) using hot air. When preheated in this manner, the particulate thermoplastic material will remain in a non-molten state in the hopper, but will more rapidly melt in the continuous melt processor. The use of preheated air also tends to remove thermally labile water from the thermoplastic marking material, which improves melt processing. However, preheating the particulate thermoplastic marking material is generally not considered to be necessary for the operation of the apparatus.

In one embodiment, the particulate thermoplastic marking material is packaged in 50 lb. bags or boxes, which can be easily opened and dumped into the hopper 20 by hand as needed. In another embodiment, the particulate thermoplastic marking material is packaged in intermediate bulk containers (e.g., totes, Gaylord containers, or SUPER SAKS) that can hold as much as 1,000 lbs or more of the particulate material. Conventional material handling equipment can used to transfer the particulate thermoplastic marking material from the intermediate bulk container(s) to the hopper 20, as needed. The size of the hopper 20 is not per se critical.

The apparatus 10 can be mounted to a skid or other movable frame 50. More preferably, however, the apparatus is integrally mounted to the deck of a truck and is thus self-propelled. The deck of the truck can further comprise a loading station where one or more pallets of particulate thermoplastic marking material can be placed. An operator can thus transfer the particulate thermoplastic marking material placed at the loading station into the hopper 20 as needed. The apparatus can further comprise a generator for providing electricity to run the motor for the continuous melt processor 30 and the electrical band heaters 80, and a control station wherein an operator can control and monitor the various components of the apparatus and the pavement marking operation.

Optionally, a drop-on glass bead dispenser such as a Kamber model 90H0 glass gun available from Lafarge Road Marking, Inc. of Parsippany, N.J., can be used with the apparatus. In such event, the apparatus will further comprise a glass bead tank that supplies glass beads to the gun.

In the preferred embodiment of the invention, more than one apparatus 10 according to the invention is integrally mounted to the same truck. When more than one apparatus is mounted to a truck, it is possible to simultaneously apply more than one color of thermoplastic marking material to a pavement surface at the same time. Thus, it is possible to apply a yellow dividing line on a center portion of a highway while at the same time applying a white pavement marking line on the right side of a highway. The loading station in such an arrangement will include an area for receiving both a supply of white particulate thermoplastic marking material and yellow particulate thermoplastic marking material.

The present invention also provides a method of applying a thermoplastic marking material to a pavement surface. In accordance with the method, a stream of particulate thermoplastic marking material stored in a non-molten state in a hopper is conveyed to a heated continuous melt processor in communication with the hopper. The thermoplastic marking material exits the continuous melt processor in a molten state and is pumped through a heated conduit from the continuous melt processor to a dispenser that directs the molten thermoplastic marking material to the pavement surface.

Unlike conventional application methods, a large volume of thermoplastic marking material is not kept in a molten state in a kettle or hopper. On the contrary, the particulate thermoplastic marking material is kept in a non-molten state in the hopper and is melted as it progresses from the hopper through the heated continuous melt processor. It will be appreciated that some melting can occur slightly ahead or upstream of the continuous melt processor, but is completed by the time the thermoplastic marking material exits the melt processor.

In accordance with the apparatus and method of the invention, it is possible to form a stripe on a pavement surface that is up to about 6.0 inches wide, and more preferably from about 4.0 to about 6.0 inches wide, and up to about 0.125 inches thick, and more preferably about 0.090 inches thick, at a speed of up to about 8 miles per hour. This makes the apparatus according to the invention particularly useful for long striping operations, such as centerlines, dividing lines, and pavement marking lines.

Another advantage provided by the apparatus according to the invention is improved safety. Conventional kettles or hoppers that are used to maintain relatively large volumes of thermoplastic marking material in a molten state must be equipped with special safety apparatus that are intended to prevent “flashing” and spillage of the molten thermoplastic material. Because the apparatus according to the invention does not maintain large volumes of thermoplastic marking material in a molten state, there is little danger of “flashing” or spillage. This greatly increases operator safety.

Additional advantages and modifications will readily occur to those skilled in the art. Therefore, the invention in its broader aspects is not limited to the specific details and illustrative examples shown and described herein. Accordingly, various modifications may be made without departing from the spirit or scope of the general inventive concept as defined by the appended claims and their equivalents.

What is claimed is:

1. An apparatus for applying thermoplastic marking material to a pavement surface, the apparatus comprising:
a hopper for holding a supply of particulate thermoplastic marking material in a non-molten state;
means for conveying the thermoplastic marking material from the hopper to a continuous melt processor;
a conduit from the continuous melt processor to a dispenser that directs molten thermoplastic marking material to the pavement surface; and
means for heating the continuous melt processor and conduit to a temperature that is higher than the melt temperature of the thermoplastic marking material.

2. The apparatus according to claim 1 wherein the means for conveying the thermoplastic marking material from the hopper to the continuous melt processor is an auger.

3. The apparatus according to claim 2 further comprising means for heating a portion of the auger proximal to the continuous melt processor.

4. The apparatus according to claim 3 wherein the means for heating a portion of the auger proximal to the continuous melt processor is an electrical band heater.

5. The apparatus according to claim 1 wherein the means for heating the progressive cavity pump is an electrical band heater.

6. The apparatus according to claim 1 wherein the means for heating the conduit is an electrical band heater.

7. The apparatus according to claim 1 further comprising means for heating the dispenser.

8. The apparatus according to claim 1 wherein the dispenser that directs molten thermoplastic marking material to the pavement surface is a spray dispenser.

9. The apparatus according to claim 1 wherein the dispenser that directs molten thermoplastic marking material to the pavement surface is a screed extrusion device having a slide door.

10. The apparatus according to claim 1 wherein the dispenser that directs molten thermoplastic marking material to the pavement surface is a ribbon gun.

11. The apparatus according to claim 1 wherein the continuous melt processor comprises a single-screw rotary pump.

12. The apparatus according to claim 1 further comprising a manifold for distributing molten thermoplastic marking material to a plurality of dispensers that direct molten thermoplastic marking material to the pavement surface, the manifold being disposed in fluid communication between the continuous melt processor and the plurality of dispensers.

13. The apparatus according to claim 1 wherein the particulate thermoplastic marking material is in the form of pellets, granules, flakes, powder or combinations thereof.

14. The apparatus according to claim 1 further comprising a command center, the command center providing a user of the apparatus with means to control the rate at which the particulate thermoplastic marking material is fed into the continuous melt processor, means to control the temperature of the continuous melt processor, and means to control the dispensers that direct thermoplastic marking material to the pavement surface.

15. A self-propelled apparatus for applying thermoplastic marking material to a pavement surface, the apparatus comprising:
a hopper for holding a supply of particulate thermoplastic marking material in a non-molten state;
an auger for conveying the thermoplastic marking material from the hopper to a continuous melt processor;
a conduit from the continuous melt processor to a manifold that selectively distributes molten thermoplastic marking material to one or more of a plurality of spray dispensers in fluid communication with the manifold, the spray dispensers directing molten thermoplastic marking material to the pavement surface; and
means for heating the continuous melt processor and conduit to a temperature that is higher than the melt temperature of the thermoplastic marking material.

16. The apparatus according to claim 15 wherein the means for heating the progressive cavity pump is an electrical band heater.

17. A method of applying a thermoplastic marking material to a pavement surface comprising:
conveying a stream of particulate thermoplastic marking material stored in a non-molten state in a hopper to a heated continuous melt processor in communication with the hopper, the stream of thermoplastic marking material exiting the continuous melt processor in a molten state; and
pumping the stream of molten thermoplastic marking material through a heated conduit from the continuous melt processor to a dispenser that directs the molten thermoplastic marking material to the pavement surface.

18. The method according to claim 17 wherein the molten thermoplastic marking material is directed to the pavement surface by the dispenser to form a stripe on the pavement surface that is from about 1.0 to about 6.0 inches wide and from about 0.030 to about 0.125 inches thick.

19. The method according to claim 17 further comprising dropping glass beads on the molten thermoplastic marking material after it has been directed to the pavement surface.

20. The method according to claim 17 wherein the continuous melt processor is heated using one or more electrical band heaters.
